(19) United States
(12) Patent Application Publication
(10) Pub. No.: US 2011/0001748 A1
(43) Pub. Date: Jan. 6, 2011

(54) ELECTRONIC DISPLAY CONTROLLER

(75) Inventors: Serge RUTMAN, Boulder Creek, CA (US); Samson HUANG, Saratoga, CA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: FIRSTPAPER LLC, New York, NY (US)

(21) Appl. No.: 12/497,199

(22) Filed: Jul. 2, 2009

(51) Int. Cl. G06F 3/038; G09G 3/34

(52) U.S. Cl. 345/214; 345/107

(57) ABSTRACT

A system for and method of controlling an electronic display, such as an electrophoretic display, are disclosed. The system and method provide for transparent translation of standard image data into signals sufficient to drive such displays and implement the corresponding image.

### FIELD OF THE INVENTION

The present invention generally relates to a system for and method of controlling an electronic display.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram of an electronic paper display (“EPD”) controller in an electronic book according to an embodiment of the present invention;

FIG. 2 is a schematic diagram of an EPD controller 200 according to an embodiment of the present invention;

FIG. 3 is a logic diagram of full screen update logic according to an embodiment of the present invention;

FIG. 4 is a flow chart illustrating a parallel pixel update according to an embodiment of the present invention;

FIG. 5 is a pixel pipeline diagram illustrating a parallel pixel update according to an embodiment of the present invention; and

FIG. 6 is a schematic diagram that illustrates frame buffer caching according to an embodiment of the present invention.

### DETAILED DESCRIPTION OF EMBODIMENTS

Certain embodiments of the present invention provide a controller for a display. More particularly, certain embodiments of the present invention provide a system for and method of controlling electronic paper displays (referred to herein as “EPD”), such as electrophoretic displays or electro-wetting displays. Examples of such displays include those disclosed in U.S. Pat. Nos. 6,577,433, 6,529,313, 6,525,866, 6,574,034, 6,017,584, 6,067,185, 6,118,426, 6,120,839, 6,124,851, 6,130,774, 6,172,798, 6,177,921, 6,232,950 and 6,249,271.

EPD generally present engineering issues that are absent from, for example, cathode ray tube (“CRT”) displays. One example has to do with how EPD use electrostatic forces to create images. A single EPD may utilize positive, negative and neutral voltages to affect image depictions and image changes. More particularly, each EPD pixel may receive (at different times) positive, negative or neutral voltages, which, in combination, select the color or shade of gray embodied in such pixel. The use of both positive and negative voltages generally implicates the use of a controller that can translate image data (e.g., in the form of data on a pixel bus) into signals sufficient to affect the display of the corresponding image on an EPD. Certain embodiments of the present invention therefore provide a controller that can translate image data received from a host system into signals (e.g., sequences of targeted positive and negative voltages) that may be applied to an EPD to display and change images.

Another engineering issue example arises due to EPD response times. EPD generally respond to image changes slower than, for example, CRT displays. This may arise because some EDP require transitioning between intermediate states in order to change from displaying one image to another. This relative slowness presents engineering challenges in displaying video or real-time user interface features such as mouse pointers and cursors. As yet another example, EPD are persistent (i.e., state bistable) in that they retain their displayed image in the absence of power. The persistence of EPD images creates engineering issues that are not present in, for example, CRT displays. As yet another example, EPD may require temperature monitoring and corresponding adjustment of input parameters. These and other engineering challenges create a need for a controller that can meet the unique needs of an EPD.

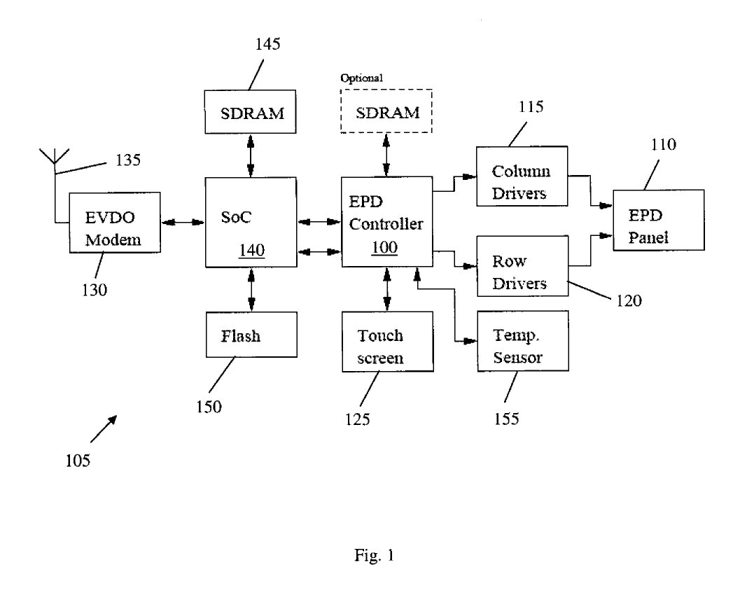

FIG. 1 is a schematic diagram of an EPD controller 100 in an electronic book 105 according to an embodiment of the present invention. EPD controller 100 is coupled to EPD 110 via column drivers 115 and row drivers 120. EPD 110 displays content in accordance with the system of electronic book 105. EPD controller 100 is also coupled to touch screen component 125 via an interface, such as a Recommended Standard 232 (RS-232) interface. The touch screen component may be coextensive with EPD 110. That is, EPD 110 may include touch screen capabilities by way of incorporation of touch screen 125. An exemplary such EPD is disclosed in U.S. patent application Ser. No. 12/332,860 entitled “Touch-Sensitive Illuminated Display,” filed Dec. 11, 2001, the contents of which are hereby incorporated by reference. EPD controller 100 is further coupled to external memory 130 via a memory interface, such as a Double Data Rate (DDR-1) SDRAM interface. External memory 130 may be, by way of non-limiting example, an SDRAM integrated circuit. EPD controller 100 is further coupled to a sub-system that allows electronic book 105 to send and receive data, such as book, magazine and newspaper content. The subsystem includes evolution data optimized (“EVDO”) modem 130, which itself is coupled to antenna 135 and to a system-on-chip application specific integrated circuit (“ASIC”) 140 via an interface, such as an Universal Serial Bus (USB) interface. ASIC 140 acts as an intermediary between EVDO modem 130 and EPD controller 100. ASIC 140 is further coupled to external volatile memory 145 (e.g., an SDRAM integrated circuit) and to external persistent memory 150 (e.g., a flash memory integrated circuit) via an interface, such as a Serial Peripheral Interface (SPI) Bus interface. An external temperature sensor 155 is coupled to EPD controller 100 via an interface, such as an Inter-Integrated Circuit (I²C) serial computer bus interface.

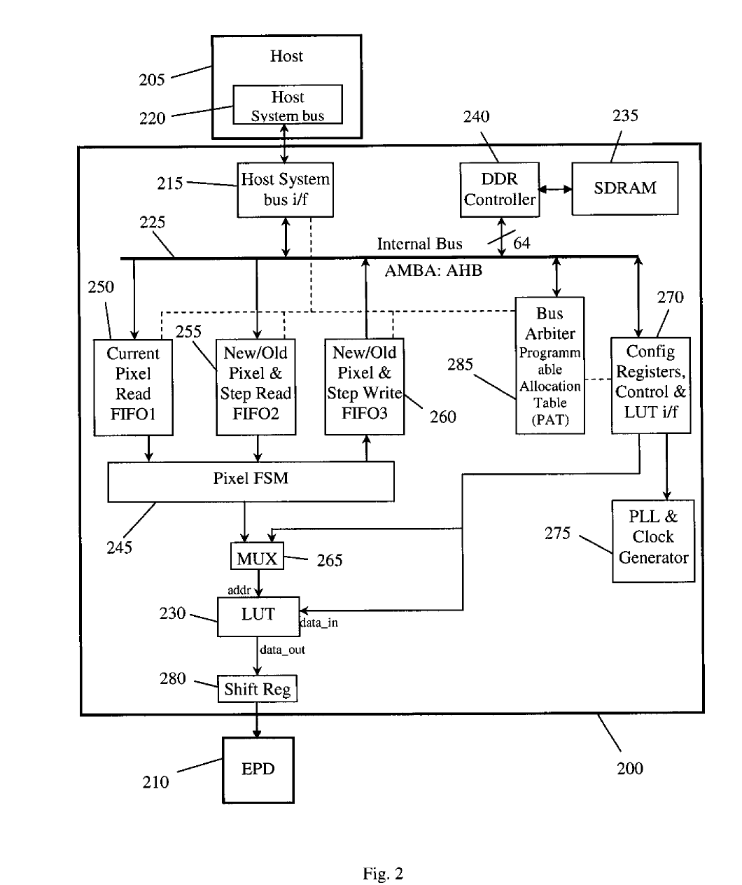

FIG. 2 is a schematic diagram of an EPD controller 200 according to an embodiment of the present invention. EPD controller 200 may be implemented on, by way of non-limiting example, an ASIC, a field programmable gate array (“FPGA”) or a dedicated integrated circuit. The embodiment illustrated in FIG. 2 may be installed in an electronic book or any other device that includes or directs an EPD.

EPD controller 200 is coupled to host 205 and to EPD 210. In general, EPD controller receives instructions and image data from host 205 and produces an output, which drives EPD 210. EPD controller thus includes a host bus interface 215. Host bus interface 215 may communicate with a host system bus 220 using the host's data flash interface. By way of non-limiting example, host system bus 220 may be an addressable bus with shared address and data input/output capabilities. Alternately, a pixel bus may be employed. The data flash interface may utilize a variable length input/output (“VLIO”) running a low order addressing mode. EPD controller 200 may use a ready pin to inform host 205 that it is ready for the next transmission. An exemplary host interface is a Monahans_LV manufactured by Marvell Semiconductor, Inc. of Santa Clara, Calif. Host system bus interface 215 is operably coupled to EPD controller internal bus 225, discussed in detail below in reference to FIG. 2.

EPD controller 200 also includes a pixel look-up table (“LUT”) 230. In general, transitioning from one image displayed on an EPD to another image displayed on an EPD (e.g., when turning a page in an electronic book) involves multiple steps. That is, changing from one image to another may involve a series of transitional images. Note that the transitional images may be too fleeting to be visible to the naked eye. Herein, an image displayed on an EPD is referred to as a “frame.” Thus, changing from one frame to another may involve multiple steps, each of which may be invisible to the observer. More particularly, changing a single pixel in a frame may involve multiple steps. With each step, EPD controller 200 causes a signal, corresponding to a transitional pixel state, to be sent to EPD 210. The signal may be a positive, negative or zero voltage. Thus, EPD controller may produce a two-bit output, where three of the four possible two-bit states correspond to positive, negative or zero voltages. By way of non-limiting example, two-bit outputs of “00” or “11” may both map to a zero volt output signal (0V), a two-bit output of “01” may map to a positive fifteen volt output signal (+15V), and a two-bit output of “10” may map to a negative fifteen volt output signal (−15V). Thus, each two-bit output causes the pixel at issue to transition to one or more different intermediate states, until the pixel reaches a final state, concluding the frame change. The collection of steps that change one displayed pixel to another are referred to herein as a “waveform.” It should be noted that a waveform may also describe a series of voltage potentials or stored data representing the series of voltage potentials.

As described in greater detail below, LUT 230 provides information regarding transitional states. More particularly, LUT 230 may accept as input a old pixel state, a new pixel state and a transition count, and output a representation of an appropriate signal for the next transitional state (or for a final state). In short, LUT 230 stores waveform information.

Waveforms may be temperature dependent. Accordingly, LUT 230 may store complete waveform data corresponding to a plurality of different temperatures, such as, by way of non-limiting example, 2, 4, 8, 16, 32, 64 or 128 different temperatures. In some embodiments, the number of different temperatures is not a power of two. Thus, some embodiments store complete waveform data corresponding to eleven different temperatures. Temperatures accounted for may range from, e.g, 125° C. through −55° C. To sense temperature, an external temperature sensor (e.g., 155 of FIG. 1) may be used. An exemplary temperature sensor is LM75 available from National Semiconductor. The temperature data may be represented in nine bits, two's complement format, with a least significant bit equal to 0.5° C. Note that EPD controller 200 accounts for temperature-dependent EPD display requirements in a manner that is completely transparent to host 205. That is, host 205 need only supply image data (e.g., in the form of data on a pixel bus) to EPD controller 200 for the corresponding image to be successfully displayed on EPD 210. Host 205 is not required to separately monitor and account for temperature-dependent EPD requirements.

EPD controller 200 also includes a memory 235, which may be internal or external to EPD controller 200. By way of non-limiting example, memory 235 is linked to EPD controller internal bus 225 via double data rate (“DDR”) controller 240. Memory 235 includes three memory sections for storing old, new and current (i.e., transitional) pixel states. The old pixel state portion of memory 235 stores the states of an existing frame or a frame that is in the midst of being transitioned to a new frame. Memory 235 also includes a new pixel state portion. The new pixel state portion stores the states of a frame to which EPD 210 is transitioning. As discussed in detail below, a portion of memory 235 stores current pixel states, which represent transitional states between the old pixel states and the new pixel states.

Current pixel state data are stored in a frame buffer portion of memory 235. Frame buffer portion of memory 235 is visible to host 205. The current pixel state data stored in frame buffer portion of memory 235 are intended to represent actual pixel states, including intermediate or transitional steps between frames. That is, the current pixel states may correspond to portions of a waveform between new and old pixel states. Memory 235 also includes a step counter portion for tracking which step of a multi-step frame transition is being processed. Memory 235 further includes a step counter portion for tracking each step of a multi-step pixel transition for each pixel. Accordingly, each pixel may be independently updated. In some embodiments, there are up to 256 steps between any two frames; in such embodiments, the step counter portion of memory 235 may be eight bits long so that up to 256 steps may be tracked.

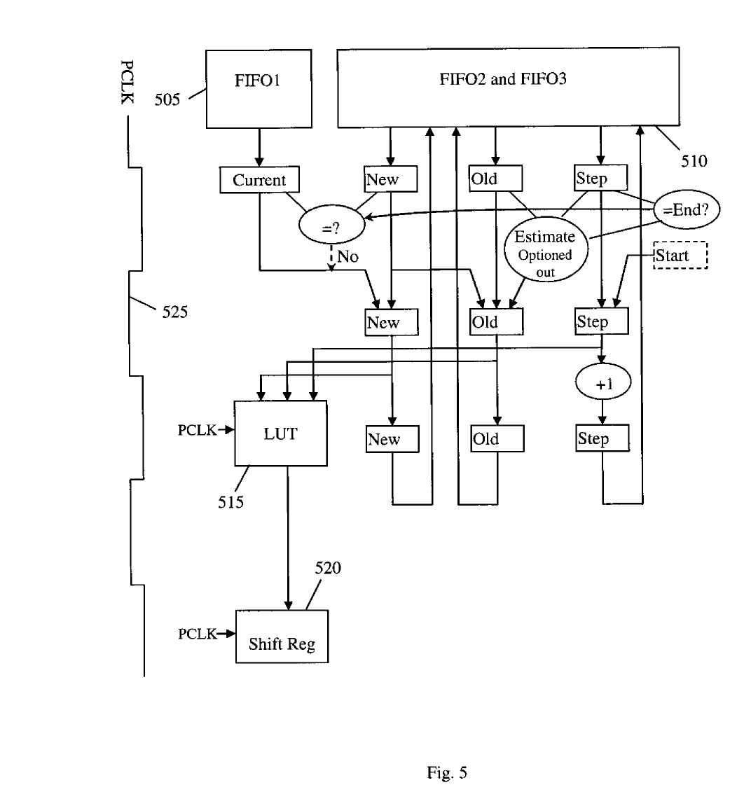

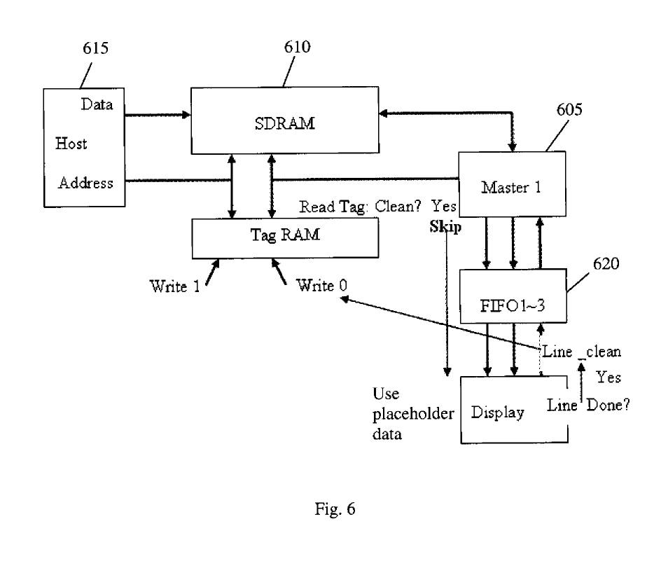

The frame buffer portion of memory 235 may be treated as a pixel cache. This caching feature can significantly reduce memory 235 bandwidth requirements when only a portion of a frame is updated (described below in reference to FIGS. 5 and 6).

The frame buffer portion of memory 235 may be divided up into a number of “lines” for pixel processing purposes. Each line may be consistent with the size of a burst read from memory 235. Burst reads of 32 and 128 bits may be selected. Note that each burst read from frame buffer portion of memory 235 may contain bits that represent 16 current pixels or four old and new pixel pairs. By way of non-limiting example, each frame may consist of 3750 lines.

A line is referred to as “clean” if all the pixels in the line have completed their update in the EPD 210 (i.e., all the pixels in the line meet the conditions of “current pixel=new pixel=old pixel,” and “step count=end”). A line is referred to as “dirty” if the host writes one or more new current pixels into the line.

During display update, the entire new frame may be scanned, line-by-line. During such scanning, the clean lines may be skipped so that the number of transactions with memory 235 is reduced. If host 205 only updates a small region of the image, many unnecessary burst reads of memory 235 can be skipped, and significant power saving can be achieved.

The caching feature of the frame buffer portion of memory 235 may be used to reduce memory 235 bandwidth requirements by reducing the amount of memory accesses (e.g., by burst read) of memory 235. In one embodiment, each line of the frame buffer portion of memory 235 may be associated with a clean/dirty bit that is stored in the frame buffer and indicates the clean or dirty status of the line. A line that is determined to be clean may be associated with a clean/dirty bit that is stored in the frame buffer portion of memory 235 and has a high value (e.g., the value of one (1)). A line that is determined to be dirty may be associated with a clean/dirty bit that is stored in the frame buffer portion of memory 235 and has a low value (e.g., the value of zero (0)). Accordingly, the clean/dirty bit of each line may be accessed in the frame buffer portion of memory 235.

Lines that are associated with a clean/dirty bit that indicates a clean line may not be scanned or accessed. That is, clean lines may be skipped such that the amount of memory accesses are reduced. Lines that are associated with a clean/dirty bit that indicates a dirty line may be and, or a combination, of scanned and accessed. For example, a dirty line may be scanned or accessed using a burst read.

EPD controller 200 also includes a pixel finite state machine (“FSM”) 245 operatively coupled to EPD internal bus 225 via three buffers (e.g., first-in/first-out (“FIFO”) buffers 250, 255, 260). In particular, current pixel read FIFO buffer 250 is coupled to EPD controller internal bus 225, from which it receives current pixel data. An output of current pixel read FIFO buffer 250 is coupled to an input of FSM 245, which receives current pixel data. New/old pixel and step data read FIFO buffer 255 is coupled to EPD controller internal bus 225, from which it receives new and old pixel and step count data. New/old pixel and step data read FIFO buffer 255 is also coupled to FSM 245, to which it sends new and old pixel and step count data. New/old pixel and step data write FIFO 260 is coupled to FSM 245, from which it receives new and old pixel and step count data. New/old pixel and step data write FIFO 260 is also coupled to EPD controller internal bus 225, to which it sends such data. An output of FSM 245 is coupled to one input of multiplexer 265. Another input of multiplexer 265 is coupled to interface 270. Interface 270 is bi-directionally coupled to EPD controller internal bus 225. Interface 270 is also coupled to phase locked loop (“PLL”) and clock 275. Interface 270 is also coupled to LUT 230. An output of multiplexer 265 is coupled to LUT 230. An output of LUT 230 is coupled to shift register 280, which is coupled to EPD 210.

In some embodiments, FSM 245 keeps track of line numbers. At the beginning of the frame (i.e., at the beginning of the first line), FSM 245 may generate a frame_synch signal; at beginning of each line, it may generate a line_synch signal. In some embodiments, EPD 210 has 1200 lines, with each line including 1600 pixels. The frame_synch and line_synch signals may be used by LUT 230.

A bus arbiter 285 is bi-directionally coupled to EPD controller internal bus 225. Bus arbiter 285 includes an internal programmable allocation table. Bus arbiter 285 is further coupled to each FIFO buffer 250, 255, 260 and to interface 270. Thus, bus arbiter is able to control and arbitrate signals on internal bus 225.

An EPD controller according to certain embodiments of the present invention may have four different modes of changing content displayed on an EPD. Each mode provides a different technique for changing an image on an EPD. A first such mode is referred to herein as an “initialization mode.” The initialization mode serves to prepare the EPD to display images after returning from a power off state. The initialization mode may operate by performing any, or a combination, of the following steps. The initialization mode may load initialization waveforms into LUT 230. The initialization mode may also load current pixel data into the frame buffer portion of memory 235 such that the initialization waveforms are triggered to display. Further, the initialization mode may write zeroes (0) to the frame buffer portion of memory 235, the old pixel data, the new pixel data, and one or more step counters.

A second mode is referred to herein as a “monochrome mode.” The monochrome mode operates such that pixels may be in only one of two states (e.g., black or white). Monochrome mode may utilize a single bit per pixel (e.g., set to zero for black and one for white). In monochrome mode, mono-update waveforms may be used. In some embodiments, mono-update waveforms only include black-to-white and white-to-black transitions, with contiguous positive or negative pulses. In this case, the waveform can be consolidated into fewer steps with a standard or slower source driver clock. Monochrome mode can significantly reduce panel power consumptions.

Images displayed in monochrome mode may generally change faster than in grayscale modes. Accordingly, monochrome mode may be used to display video on an EPD. That is, monochrome mode is sufficiently agile to allow for displaying full-screen or partial-screen video images without noticeable lag. Alternately, or in addition, monochrome mode may be used to display cursors, typed or otherwise selected text, and pointers. More particularly, monochrome mode may be used to display a mouse or touchscreen pointer, such as an arrow displayed on an EPD. Because features mentioned in this paragraph may change relatively rapidly, the agility provided by monochrome mode can accommodate their display on an EPD.

The third mode is referred to herein as “grayscale mode.” Grayscale mode operates to display images that may incorporate a plurality of shades of gray (e.g., 3, 4, 8, 16, 32, 64, 128 or 256 such shades, including black and white).

The fourth mode is referred to herein as “grayscale clean mode.” Grayscale clean mode operates by first performing an initialization mode and then following it with a grayscale mode. Thus, grayscale clean mode first clears any image present on the EPD and then displays a subsequent image in grayscale mode. Although four modes are discussed herein, such modes are exemplary only; other modes are possible and contemplated as being used with embodiments of the present invention.

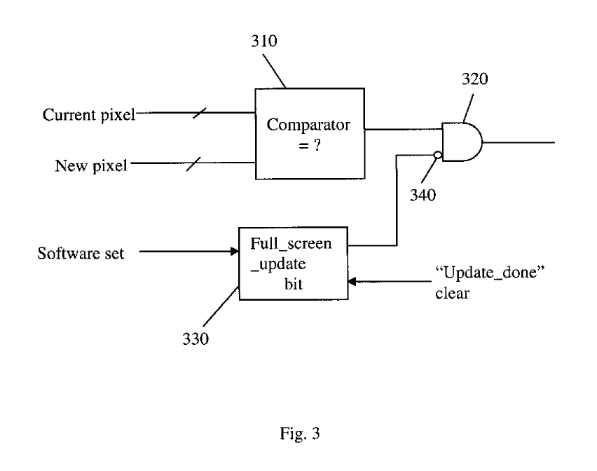

FIG. 3 is a logic diagram of full screen update logic according to an embodiment of the present invention. The full screen update mode resets the associated EPD to a known status. Note that, in general, it is possible for data displayed on an EPD to be out of synch with the data in system memory (e.g., the frame buffer portion of memory 235) that is supposed to represent the data being displayed. This may occur due to a variety of circumstances, such as voltage fluctuations, error propagation, temperature change, time (unchanged pixels may fade over time), etc. The full screen update mode resets the EPD to a known state, so that the data in system memory matches the EPD display image and so that subsequent images may be displayed correctly. To accomplish this, the full screen update mode causes the EPD to perform a clean-up operation, before transitioning to a final level for all pixels (even if the new and current pixels are the same). The final level may be black, white or any shade of gray. The full screen update mode may be initiated by the host.

Because other update modes may only act on pixels whose value has changed, a gate may be inserted after a pixel value comparator in order to accommodate the full screen update mode. Thus, FIG. 3 depicts a pixel comparator 310, which outputs a logical 1 if a current pixel is identical to a new pixel, and outputs a logical 0 otherwise. An output of comparator 310 feeds into an AND gate 320. An output of a full screen update bit store 330 also feeds into AND gate 320 through a NOT gate 340. Thus, if an full screen update bit is not set, the output of full screen update bit store is a logical 0, which is converted to a logical 1 by NOT gate 340, resulting in AND gate 320 outputting exactly the state that it receives from pixel comparator 310. On the other hand, if a full screen update bit is set at update bit store 330, its output is a logical 1, which is converted to a logical 0 by NOT gate 340, resulting in AND gate 320 outputting a logical zero despite the state that it receives from pixel comparator 310. Full screen update bit store 330 may be reset by activating a clear bit.

A full screen update mode may proceed by rapidly transitioning all pixels in the EPD from black to white and back. Such transitions may occur as part of the full screen update mode several times (e.g., 2, 3, 5, 10, 15, 16, 20, 32 or more). Once the transitions have completed, the EPD is set to a final value, which may be black, white, or any shade of gray. Note that during the transitions, the EPD may be set to standby mode in order to disable the display.

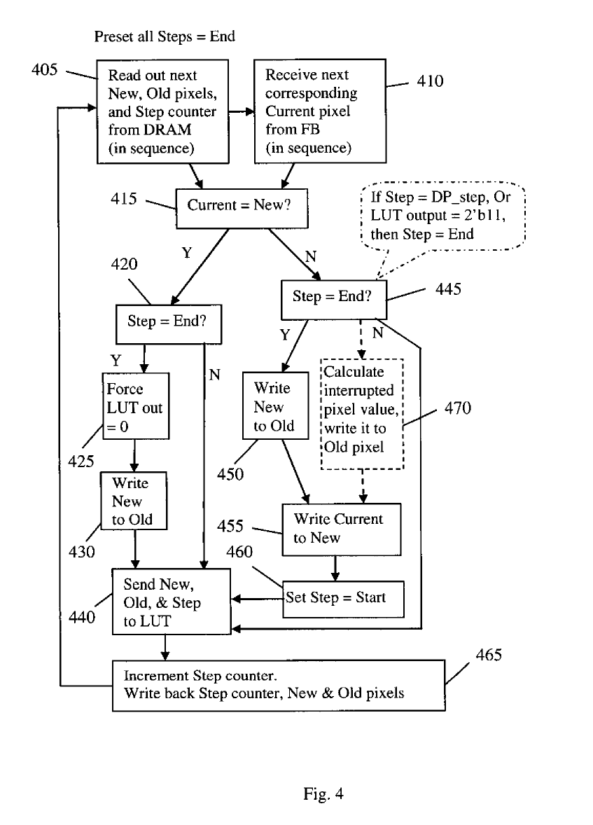

The modes (monochrome, grayscale and grayscale clean) may be performed using a partial update (discussed presently) or a parallel update (discussed below in reference to FIG. 4). In general, after completion of one frame update, all the new and current pixels are the same, and all step counters are reset to zero. For a partial update, in the next scanning loop, if the current pixels are changed and the step count is not zero, these pixels start to update while the rest of the screen is unchanged. That is, a partial update updates only the pixels that have changed. For example, after previous update is done, when scanning to the middle of a frame, the current pixel may be different from the new pixel. In such instances, a partial update may cause this pixel to begin an update procedure without waiting for the process to loop back to the beginning of the frame.

In general, for each mode, when all the waveforms reach the end, and all the current and new pixels are equal, the frame update has completed. At this point, the EPD controller may set a register bit that indicates a frame update has completed to a logical 1, and the EPD may stop running to save power.

FIG. 4 is a flow chart illustrating a parallel pixel update according to an embodiment of the present invention. For a parallel update, each pixel has its own step counter to track its update process. When a pixel value is changed in the frame buffer, that pixel will update right away without waiting for others. In general, the parallel update process continues by sending new pixel data, old pixel data and step counter information to the LUT, which produced output data for the EPD, until the waveform reaches its end. If a current pixel differs from the corresponding new pixel (i.e., the pixel value has changed), then the pixel FSM will take actions to process it.

The process starts at block 405 by reading out the next values of new pixel, old pixel and step counter, e.g., from memory 235. At block 410, the next value for the current pixel is read, e.g., from frame buffer portion of memory 235. At block 415, the current pixel value is compared to the new pixel value (e.g., using a logical structure as depicted in FIG. 3). If the current pixel is the same as the new pixel (i.e., no change), the process branches to block 420, where the associated step counter is polled to determine whether the waveform is at an end. If the waveform is at an end (i.e., all transitional states of the pixel have been processed), the process branches to block 425, in which the LUT is forced to produce a designated end value (e.g., 0) when polled. After block 425, at block 430, the new pixel information is written to the old pixel portion of memory, and the process proceeds to block 440. If, at block 420, the step counter for the pixel indicates that the waveform is in progress, the process proceeds directly to block 440. At block 440, the old pixel value, the new pixel value and the step counter value are transmitted to the LUT, where output data for the EPD is retrieved.

Returning to block 415, if the current pixel value is not equal to the new pixel value, the process branches to block 445, at which the pixel step counter is polled to determine whether the waveform for that pixel is at an end. If so, then the process branches to block 450, at which the new pixel information is written to the old pixel portion of memory, and the process proceeds to block 455, where the current pixel is written to the new pixel memory. After block 455, the process proceeds to block 460, where the step counter is reset to zero, and then to block 440. If the waveform is not at an end, the process branches from block 445 to block 440, at which output data for the EPD is retrieved from the LUT.

After block 440, the process proceeds to block 465, at which the step counter for the pixel is incremented, and the new and old pixel data is updated in memory. The process then returns to block 405, completing one iteration of the parallel update procedure for one pixel.

Note that, in general, the LUT indicates an output to an EPD when provided with an old pixel value, a new pixel value and a step count, which indicates a current transitional state of the associated waveform. If a pixel is in the midst of an update operation (i.e., the associated waveform has not yet been fully processed), a new waveform generally cannot be started unless a starting old pixel value is provided to the LUT. However, intermediate pixel values may be difficult to ascertain, as in some embodiments a pixel's value cannot be determined by polling the EPD itself. Therefore, certain embodiments of the present invention provide a waveform interruption feature, which allows a new waveform to begin prior to an existing waveform's end. That is, a waveform interrupt feature may be used to begin a new waveform prior to an existing waveform's completion. In order to do so, the waveform interrupt feature estimates an intermediate pixel value based on the old pixel value, the new pixel value and the current step count (all previously provided to the LUT). The waveform interrupt feature estimates the current pixel value, and supplies this value as the old pixel value in order to begin a new waveform. That is, the waveform interrupt feature may proceed by supplying the LUT with an old pixel value, which is an estimate, a new pixel value, which represents the new target pixel, and a step count, which may be zero (a zero value may signify that a new waveform is to begin).

Returning now to FIG. 4, at block 445, embodiments that implement a waveform interrupt feature may proceed to block 470 instead of block 440 in the event that the current waveform has not finished. That is, certain embodiments may implement a waveform interrupt feature if the current pixel value is not equal to a new pixel value (as determined at block 415) and if the step counter is not at an end (as determined at block 445). At block 470, the current pixel value is estimated based on the old pixel value, new pixel value and step count, and the estimated value is written to the old pixel memory. The process then proceeds to block 455.

FIG. 5 is a pixel pipeline diagram illustrating a parallel pixel update according to an embodiment of the present invention. In particular, FIG. 5 depicts a parallel pixel update with reference to internal components of an EPD controller such as that depicted in FIG. 2. FIFO1 505 may correspond to current pixel read FIFO buffer 250 of FIG. 2, FIFO2 and FIFO3 510 may correspond to 255 and 260, LUT 515 may correspond to LUT 230, and shift register 520 may correspond to shift register 280. A pixel clock signal is depicted at 525. With each pixel clock tick, two pixels are read from FIFO1 505. Also, with each pixel clock tick, two new pixels, two old pixels and two pixel counters are read from FIFO2 and FIFO3 510. Thus, with each pixel clock tick, two pixels are processed. (Note that other embodiments, which process different numbers of pixels with each clock pulse are also contemplated.) If the current pixel and the new pixel are the same, and it is not the end of a update sequence, then this old-new pixel pair and step counter value are sent to the LUT to generate source driver data for the current step. The step counter is incremented after each step. If the update sequence reaches the end, then the new pixel is copied to the old pixel, which cause the LUT to output a zero. If the current pixel and the new pixel are different, it means the current pixel got changed. In this instance, if not during an update sequence (i.e., if at the start of an update sequence), then the process copies the new pixel data to the old pixel memory, copies the current pixel data to the new pixel memory, and starts a new update sequence for this pixel. If the current pixel and the new pixel are different, and it is during an update sequence, then the process increments the step counter by one, and continues the updating sequence. Optionally, a waveform interrupt feature may be implemented, which estimates the changing pixel value, starts a new update sequence from that value, and resets the pixel step counter to zero. Note that in both cases, the new, old, and step counter data are sent to the LUT to generate output data. The updated new and old pixel values, and the step counter values may be written back into the SDRAM after each pixel is processed.

FIG. 6 is a schematic diagram that illustrates frame buffer caching according to an embodiment of the present invention. In general, caching the contents of the frame buffer (e.g., the frame buffer portion of memory 235 of FIG. 2) provide several advantages. For example, frame buffer caching feature can significantly reduce memory (e.g. SDRAM 235 of FIG. 1) bandwidth requirements, particularly when only a partial image is updated by the host. Because the EPD is non-volatile, it can be treated as an image write-only memory. The frame buffer (i.e., current pixel memory portion) may be treated as a cache. More particularly, as discussed above in reference to FIG. 1, the frame buffer may be divided up into many “lines,” where a line is defined to be “clean” if all the pixels in the line have completed their update in the EPD panel, and a line is “dirty” if the host writes one or more new current pixels into the line. In some embodiments, all cache tags are initialized to dirty. During display update scanning, the frame buffer caching feature may allow the clean lines to be skipped, reducing the number of memory (e.g., SDRAM) transactions. A control bit may be used to turn on or off the frame buffer caching feature.

Referring to FIG. 6, master 1 (605) maintains a set of cache tags, with one bit per cache line. These tags may be stored in memory (e.g., Tag RAM 610 or SDRAM 610) either on or off of the main EPD controller. For each tag, a value of Tag=0 may indicate that the corresponding cache line is clean; a value of Tag=1 may indicate that the corresponding cache line is dirty.

In the process of scanning the frame buffer present in memory 610, master 1 (605) checks the state of the cache tag for the line to be retrieved. For a dirty cache line, the display operation may behave as if there were no frame buffer caching. If a cache line is clean, on the other hand, the read transfer of SDRAM 610 is skipped, as described above. In this case, master 1 (605) asserts a skip signal, and the EPD controller feeds placeholder data into the display pipeline (e.g., FIFO 1-3 620). Such placeholder data may consist of equal old and new pixel pairs, with step counters set to zero (i.e., “end”). Such placeholder data will cause no change in the EPD display. If host 615 only updates a small region of the image, then the frame buffer caching feature reduces the number of SDRAM burst reads, as the clean lines can be skipped, and significant power saving can be achieved.

Embodiments of the present invention may include further power management features. Since EPD are persistent, once a frame is updated, it need not be continuously refreshed. Therefore, some embodiments limit or stop power consumption by one or both of the EPD controller and the EPD itself once a frame update completes. This may be accomplished as follows. Completion of a frame update generally involves completing all steps of all associated waveforms (e.g., a separate waveform for each pixel that has changed). When all such waveforms complete their respective steps, all current pixels should equal all new pixels, as such pixels are reflected in memory. At this point, the frame update is complete. Accordingly, the EPD controller may set an update bit (e.g., Update_Done=1) to signal to its host that the update is complete. At that point, all power to the EPD may be suspended, e.g., by the EPD controller. (Upon the host updating current pixels in the frame buffer, at least one line will become dirty, and the EPD controller may resume full power operation and begin updating the frame.)

The EPD controller may enter any of a variety of low-power or no-power modes upon completion of a frame update. As one example, the EPD controller may initiate an auto-stop sequence that halts access to memory (e.g., memory 235 of FIG. 2) by stopping memory fetch sequences to the memory. The auto-stop sequence may be initiated if all new pixels stored in the memory match the current pixels and the step counters indicate the end of an update sequence. Accordingly, the auto-stop sequence may then halt the EPD controller from performing memory fetch sequences.

As another example, the EPD controller may halt access to memory (e.g., memory 235 of FIG. 2), cutting power (e.g., except V_{REF}) to the associated controller (e.g., DDR controller 240 of FIG. 2). As another example, memory (e.g., 235 of FIG. 2) may be set to self-refresh mode (e.g., cutting V_{TT} and V_{DD}). In one embodiment, V_{TT} and V_{DD} may be used during any, or a combination, of normal read and write operations in a memory device (e.g., a Double-Data-Rate Synchronous Dynamic Random Access Memory (DDR SDRAM)). For example, V_{TT} may be associated with a Input/Output termination voltage of a memory device and V_{DD} may be associated with a device supply voltage of a memory device.

As another example, the EPD controller may halt pixel scanning (e.g., a halt to the traversal of the frame buffer portion of memory 235 and a halt to the performance of one or more transformation tasks necessary to provide stimuli to the EPD to maintain display of the same frame by the EPD controller). In one embodiment, a halt of pixel scanning may result in a halt of the supply of new frames to the EPD. Accordingly, the last frame displayed on the EPD may be maintained based on the persistent nature of the EPD.

As another example, power to the core clock may be cut (this may be performed after setting the memory to self-refresh mode). As another example, power to V_{IO} may be cut. Any one, or any combination, of the examples in this paragraph may be used.

An alternate or additional power saving feature in which the host CPU may be turned off is described presently. Before the EPD controller completes a frame update, but after image information is read, the EPD controller may signal that it has completed receiving such data. The host CPU may shut down in response to such signal. In the alternative, the EPD controller may use hardware or software to initiate a suspend mode by itself and a complex programmable logic device (“CPLD”) that operates as a power controller. Suspend mode may be initiated and terminated by either hardware or software. Exemplary suspend sequences for both are discussed below.

An exemplary hardware suspend mode entrance sequence is described presently. The host first sets indicator bits that respectively indicate that the EPD power is to be automatically shut off (e.g., set Panel_pwr_auto_off=1) and that hardware is suspending the EPD controller (e.g., set HW_suspend=1). The EPD controller then polls to determine whether any pending update is complete (e.g., poll to determine whether Update_Done=1). If the poll indicates that all pending updates are complete, the host proceeds to disable the EPD. Internal to the EPD controller, if a suspend indicator bit is set to zero, then EPD controller hardware checks whether a suspend request signal is present from the CPLD (e.g., determine whether Suspend_Req=1). If so, the suspend sequence is initiated. Hardware clears any bit indicating that the EPD controller's memory is ready (e.g., set DRAM_ready=0). Hardware puts the memory interface (e.g., DDR controller 240 of FIG. 2) in self-refresh mode (e.g., by asserting a DDR_SR signal). Hardware then asserts the EPD controller's “Suspended” pin, which is connected to the CPLD, indicating that the EPD controller is in suspend mode. The CPLD deasserts the chip enabled bit (e.g., sets Chip_EN=0) to gate-off all EPD controller clocks glitch-free, disables the PLL, and disables all outputs. The CPLD may also turn off the EPD controller's input/output power.

An exemplary hardware suspend mode exit sequence is described presently. The CPLD turns on the EPD controller's input/output power. Next, the CPLD asserts a chip enabled pin (e.g., sets Chip_EN=1) to start the PLL. When a PLL lock pin is set (e.g., PLL_lock=1), hardware turns on the EPD controller's clocks glitch-free. If the suspend request bit is set to negative (e.g., Suspend_Req=0), the suspend bit is set to positive (e.g., Suspended=1), and the chip enable bit is set to positive (e.g., Chip_EN=1), then the EPD controller proceeds to exit suspend mode. Hardware exits the memory's self-refresh mode by deasserting the self-refresh bit (e.g., setting DDR_SR=0). Hardware then sets the controller's memory's ready bit to positive (e.g., set DRAM_ready bit=1) and deasserts the Suspend signal (e.g., sets Suspend=0).

An exemplary software suspend mode entrance sequence is described presently. The host sets a bit that indicates that the EPD is about to initiate an auto-off sequence (e.g., set Panel_pwr_auto_off=1) and sets a bit that indicates that the suspend mode is not hardware-initiated (e.g., set HW_suspend=0). The EPD controller then polls to determine whether any pending update is complete (e.g., poll to determine whether Update_Done=1). If the poll indicates that all pending updates are complete, then a bit indicating that the EPD controller is in suspend mode is set (e.g., set Stdby=1). The suspend bit is next polled to determine whether the EPD controller is already in suspend mode (e.g., poll whether Suspended=0). If not, a software suspend request bit is set (e.g., set SW_susp_req=1). (Note that hardware may clear a memory ready bit once the DDR is in self-refresh mode). The suspend bit is set to positive (e.g., set Suspended=1). A chip-enabled bit is set to negative (e.g., set Chip_EN=0) to gate off all EPD controller clocks glitch-free. The PLL is disabled, as are all outputs. The host can also turn off the EPD controller's input/output power (e.g., by setting Vtt_EN=0).

An exemplary software suspend mode exit sequence is described presently. The host turns on the EPD controller's input/output power (e.g., set Vtt_EN=1). The host asserts a chip-enable bit (e.g., set Chip_EN=1) to start a PLL. The process may pause to allow the PLL to lock (e.g., twenty milliseconds). The suspend request bit is set to negative (e.g., set SW_susp_req=0). Once a poll of the memory ready bit indicates the memory is ready (e.g., DRAM_ready=1), the suspend bit is set to negative (e.g., set Suspend=0).

Certain embodiments allow host systems to provide image data (e.g., in the form of data on a pixel bus) to an EPD controller, which accounts for the specific needs of EPD. In such embodiments, the EPD provides a series of output signals to the EPD to effectuate the display of the corresponding image. Such embodiments allow a host to provide image data to an EPD in essentially the same manner as it would provide image data to a CRT or LCD display. As one example, certain embodiments translate image data to appropriate waveforms, which effectuate displaying the corresponding image on an EPD. As another example, certain embodiments account for temperature-dependent EPD requirements in a manner that is completely transparent to the host. As another example, certain embodiments may allow for use of different waveforms so that trade-offs are made between speed to update a frame and resultant image fidelity.

Certain embodiments of the present invention provide an EPD controller with embedded security protection. In such embodiments, rather than requiring the host to authenticate and encrypt image data, the EPD controller performs this role. Accordingly, the EPD controller may include logic that is configured to perform various security functions (e.g., authentication functions) and logic that is configured to disable one or more portions of the EPD controller (e.g., disable the clock to disable the entire EPD controller) in the event of a security trigger (e.g., authentication failure). In one embodiment, a security trigger may allow for one or more portions of the EPD controller to remain enabled such that the EPD displays “Stolen Content,” “Your Device Has Been De-authorized, Please Call 123-456-7890 To Re-activate,” or a similar notice.

Other embodiments, uses, and advantages of the present invention will be apparent to those skilled in the art from consideration of the specification and practice of the present invention disclosed herein. The specification and drawings should be considered exemplary only, and the scope of the present invention is accordingly intended to be limited only by the following claims and equivalents thereof.

We claim:

1. A hardware implemented method for partially updating an electrophoretic display, the method comprising:
scanning a complete set of new pixel values in an electronic memory;
comparing, during the scanning and using logical circuitry, the new pixel values to existing pixel values;
determining, during the scanning and based on the comparing, a set of pixels whose values have changed;
initiating an update sequence for each pixel in the set of pixels whose values have changed, wherein the initiating occurs during the scanning, and wherein at least one update sequence comprises delivering a series of voltage potentials to a portion of the electrophoretic display corresponding to a changed pixel.

2. The method of claim 1 further comprising, prior to the scanning, delivering a second series of voltage potentials to each pixel in the electrophoretic display, wherein each pixel is cycled through black and white states at least once, whereby each pixel is set to a same state.

3. The method of claim 1 or 2, wherein the first series of voltage potentials comprises a grayscale transition.

4. The method of claim 1, wherein the first series of voltage potentials consists of black to white and white to black transitions.

5. A hardware implemented method for updating an electrophoretic display in parallel, the method comprising:
providing an electronic memory storing a current pixel value for each pixel in the electrophoretic display;
providing an electronic memory storing a new pixel value for each pixel in the electrophoretic display;
providing a hardware implemented step counter for each pixel in the electrophoretic display;
identifying a changed pixel, wherein a current pixel value for the changed pixel is different from a new pixel value for the changed pixel;
determining, for the changed pixel, whether a step counter associated with the changed pixel indicates that the pixel is transitioning to a new pixel value;
retrieving from an electronic memory a signal value associated with the current pixel value for the changed pixel, the new pixel value for the changed pixel and a step counter value for the changed pixel;
providing the signal value to a portion of the electrophoretic display corresponding to the changed pixel; and
updating the step counter value associated with the changed pixel.

6. The method of claim 5 further comprising, prior to the identifying, delivering a series of voltage potentials to each pixel in the electrophoretic display, wherein each pixel is cycled through black and white states at least once, whereby each pixel is set to a same state.

7. The method of claim 5 or 6, wherein the signal value corresponds to a shade of gray.

8. The method of claim 5, wherein the signal value corresponds to either black or white.

9. The method of claim 5, further comprising repeating, substantially in parallel and for a plurality of pixels, the steps of identifying, determining, retrieving, providing the signal value and updating.

10. A system for controlling an electrophoretic display, the system comprising:
a computing apparatus configured to store an existing frame, wherein the existing frame comprises a plurality of existing lines, wherein each existing line comprises a set of existing pixel values;
a computing apparatus configured to receive a new frame from a host system, wherein the new frame comprises a plurality of new lines, wherein each new line comprises a set of new pixel values;
a computing apparatus configured comparing each existing pixel value to a corresponding new pixel value to determine a set of pixels whose values have changed; and
a computing apparatus configured to deliver a series of voltage potentials to a portion of the electrophoretic display corresponding to a changed pixel.

11. The system of claim 10, wherein a computing apparatus is configured to treat each new line associated with at least one changed pixel as a clean line.

12. The system of claim 10, wherein a computing apparatus is configured to treat each new line associated with unchanged pixel values as a dirty line.

13. The system of claim 12, wherein a computing apparatus is configured to scan each dirty line.

14. A system for controlling an electrophoretic display, the system comprising:
a computing apparatus configured to detect an end of an update sequence;
a computing apparatus configured to initiate a suspend power sequence in response to the detection of the end of the update sequence; and
a computing apparatus configured to halt at least one memory fetch sequence based on the initiation of the suspend power sequence.

15. The system of claim 14, wherein the computing apparatus is further configured to detect the end of the update sequence by detecting when current pixel data equals new pixel data.

16. The system of claim 14, wherein the computing apparatus is further configured to detect the end of the update sequence by detecting when one or more step counters indicate the end of the update sequence.
